(19) United States
(12) Patent Application Publication
(10) Pub. No.: US 2019/0064347 A1
(43) Pub. Date: Feb. 28, 2019

(54) System and Method for Detecting Misidentified Hydrometeors in Weather Radar Data

(71) Applicant: Weather Analytics LLC, Dover, NH (US)

(72) Inventors: Justin Jones, Somerville, MA (US); Leigh Ann Munchak, Silver Spring, MD (US); Stefan Francis Cecelski, Odenton, MD (US)

(21) Appl. No.: 15/695,467

(22) Filed: Sep. 5, 2017

Related U.S. Application Data
(63) Continuation of application No. 15/690,746, filed on Aug. 30, 2017.

(51) Int. Cl. G01S 13/95; G06N 3/08; G06N 3/04

(52) U.S. Cl. CPC G01S 13/95; G06N 3/0445; G06N 3/08

(57) ABSTRACT

A system for detection of misidentified hydrometeors includes a raw radar null event identifier and a null event time sequence creator. The raw radar null event identifier is configured to receive weather radar data and null event information and to identify a null event in the weather radar data. The null event time sequence creator is configured to receive the null event from the raw radar null event identifier and to form a null event time sequence based on the null event.

### CROSS-REFERENCE TO RELATED APPLICATIONS

This application is a continuation of, and claims the benefit of priority to, co-pending U.S. patent application Ser. No. 15/690,746, entitled Radar Artifact Reduction System for the Detection of Hydrometeors, which was filed on Aug. 30, 2017, the disclosure of which is incorporated herein by reference in its entirety.

### FIELD OF THE INVENTION

The present invention relates to meteorological systems, and more particularly, is related to weather prediction systems.

### BACKGROUND OF THE INVENTION

Current meteorological radar systems, particularly dual polarized radar systems that transmit either sequential or simultaneous pulses of horizontally and vertically polarized electromagnetic waves, allow meteorologists and others to discriminate among precipitation types, such as rain, hail, or snow. These systems enable identification of storm motion, speed, and rotation through Doppler derived velocity measurements.

A hydrometeor may be any product of condensation or deposition of atmospheric water vapor, whether formed in the free atmosphere or at the surface of the earth. A hydrometeor may also be formed as a water particle blown by the wind from the surface of the earth, for example from a body of water.

Hydrometeor classification has been achieved via a variety of techniques, such as measuring the consistency of the horizontal and vertical returned power and phase for each pulse, known as the “correlation coefficient.” Because the shape of some hydrometeors, such as raindrops may remain fairly uniform within a radar scan volume, there may be minimal variation between the horizontal and vertical channels, and thus, may be characterized by values of correlation coefficient approaching 1. Other hydrometeors, such as hail (and especially very large hail), may be characterized by low correlation coefficients, as do irregularly shaped objects, such as storm debris or wildlife (e.g., insects).

The ability to classify hydrometeors is, however, often hampered by radar data anomalies and non-meteorological back scatterers such as ground clutter. A variety of techniques have been used to determine when radar data accurately represents observed meteorological phenomena. One technique for data quality assessment is to calculate the level of variability in radar data characteristics for a given event. For instance, data quality assessments have been formulated that rely on the standard deviation of the differential phase shift coupled with measurement of the correlation coefficient. By filtering out areas with highly variable differential phase and low correlation coefficients, a skilled practitioner may create a data mask to focus attention on meteorological events rather than ground obstructions, wildlife, et cetera. Other clutter reduction techniques include the use of fuzzy logic algorithms to reduce the amount of anomalous propagation clutter in Next-Generation Radar (NEXRAD) radar data, as well as targeted horizontal reflectivity ranges and thresholds specifically utilized to identify radar gates that are potentially related to biological scatters.

While such filtering mechanisms may provide a robust first pass on raw meteorological radar data volumes, they cannot be directly applied to derived radar products. Typically, these decluttering techniques are applied directly to the NEXRAD Level II volume data for a given radar site to provide cleansed (and meteorologically significant) horizontal reflectivity and radial velocity observations for downstream products. Thus, should the cleansing techniques fail to filter erroneous radar observations, downstream radar-derived products that are sensitive to such misses will contain erroneous data themselves. Moreover, filtering mechanisms based on dual polarity data such as those described above are of no use in analyzing data from single polarity, conventional Doppler radar systems. This presents a problem in analyzing historical radar data that predates the widespread implementation of dual polarized radar systems. Therefore, there is a need in the industry to address one or more of the abovementioned shortcomings.

### SUMMARY OF THE INVENTION

Embodiments of the present invention are directed to a system and method for detecting misidentified hydrometeors in weather radar data. Briefly described, a first aspect of the present invention is directed to a system for detection of misidentified hydrometeors. The system includes a raw radar null event identifier. The raw radar null event identifier is configured to receive weather radar data and null event information and to identify a null event in the weather radar data. A null event time sequence creator is configured to receive the null event from the raw radar null event identifier and to form a null event time sequence based on the null event.

A second aspect of the present invention is directed to a computer based method for detection of misidentified hydrometeors. Weather radar data and null event information is received. A null event is identified in the weather radar data based upon the null event information. The weather radar data may include raw weather radar data and/or filtered weather radar data. A null event time sequence may be formed based on the null event. Expected hail size variations over time may be identified and compared with changes in reported hail sizes over time. If the changes in reported hail sizes over time are inconsistent with expected hail size variations over time, the reported hail sizes over time may be declared as being anomalous.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The components in the drawings are not necessarily to scale, emphasis instead being placed upon clearly illustrating the principles of the present invention. The drawings illustrate embodiments of the invention and, together with the description, serve to explain the principles of the invention.

FIG. 1 is a schematic diagram of a first exemplary embodiment of an adaptive radar artifact reduction system.

FIG. 2 is a schematic diagram of a first exemplary embodiment of a null event identifier subsystem.

FIG. 3A is a first map plotting raw radar data indicating the location of falsely identified hail.

FIG. 3B is a first map plotting filtered radar data indicating the location of hail after removing null events.

FIG. 4A is a second map plotting raw radar data indicating the location of falsely identified hail.

FIG. 4B is a second map plotting filtered radar data indicating the location of hail after removing null events.

FIG. 5A is a first map plotting raw radar data indicating the location of observed hail.

FIG. 5B is a first map plotting filtered radar data indicating the location of observed hail after removing null events.

FIG. 6A is a second map plotting raw radar data indicating the location of observed hail.

FIG. 6B is a second map plotting filtered radar data indicating the location of observed hail after removing null events.

FIG. 7 is a schematic diagram illustrating an example of a system for executing functionality of the present invention.

FIG. 8 is a flowchart 800 of a first exemplary method for adaptive radar artifact reduction.

FIG. 9 is a flowchart of an embodiment of an exemplary process performed by the Spatial Consistency Checker and Filler of FIG. 1.

FIG. 10 is a schematic diagram of the first exemplary embodiment of the radar artifact reduction system indicating the data types and locations of data transformation.

### DETAILED DESCRIPTION

The following definitions are useful for interpreting terms applied to features of the embodiments disclosed herein, and are meant only to define elements within the disclosure.

As used within this disclosure, a “null event” refers to a weather event that provides a false positive result, for example, instances in which the weather event indicates conditions such as intense rain, hail, and/or wind, but such conditions are not present.

As used within this disclosure, a “temporal sequence” refers to a selection of data points over two or more sets of weather data associated with two or more times (or timestamps) that may indicate the occurrence of a weather event at the associated times.

As used within this disclosure, a “fingerprint” refers to a sequence of data points in collected weather data that may be used to identify a weather event, or may be used to identify a null event that may otherwise mistakenly be identified as a weather event.

Reference will now be made in detail to embodiments of the present invention, examples of which are illustrated in the accompanying drawings. Wherever possible, the same reference numbers are used in the drawings and the description to refer to the same or like parts.

Exemplary embodiments of the present invention may be directed to an automated method and/or system that ingests and cleanses (filters) real-time radar product data to isolate impactful weather events that result from meteorological phenomena such as rain, hail, and wind (rotational and straight-line). The filters may identify radar artifacts resulting in null events, such that the method and/or system refines itself as null events occur, increasing the accuracy of the filter as time progresses.

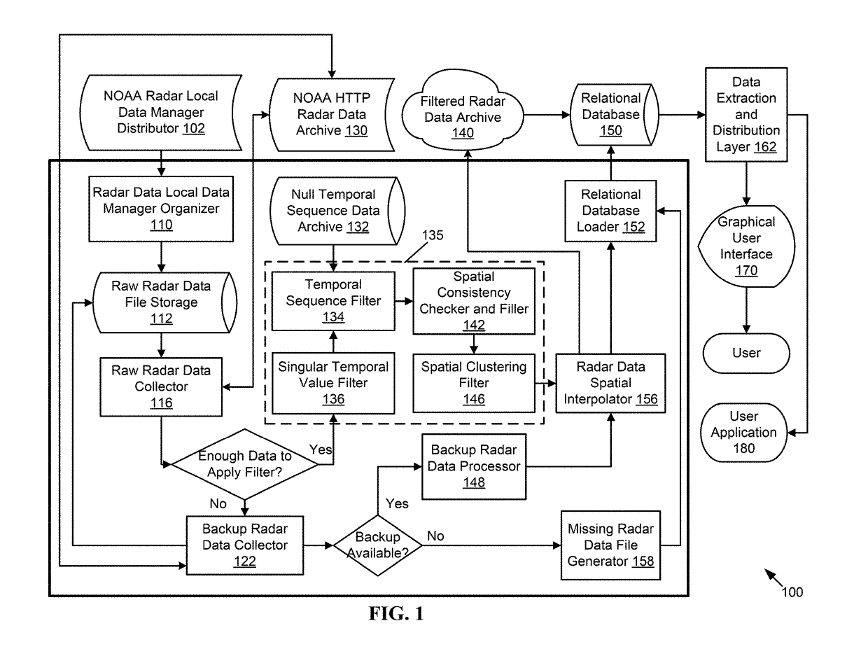

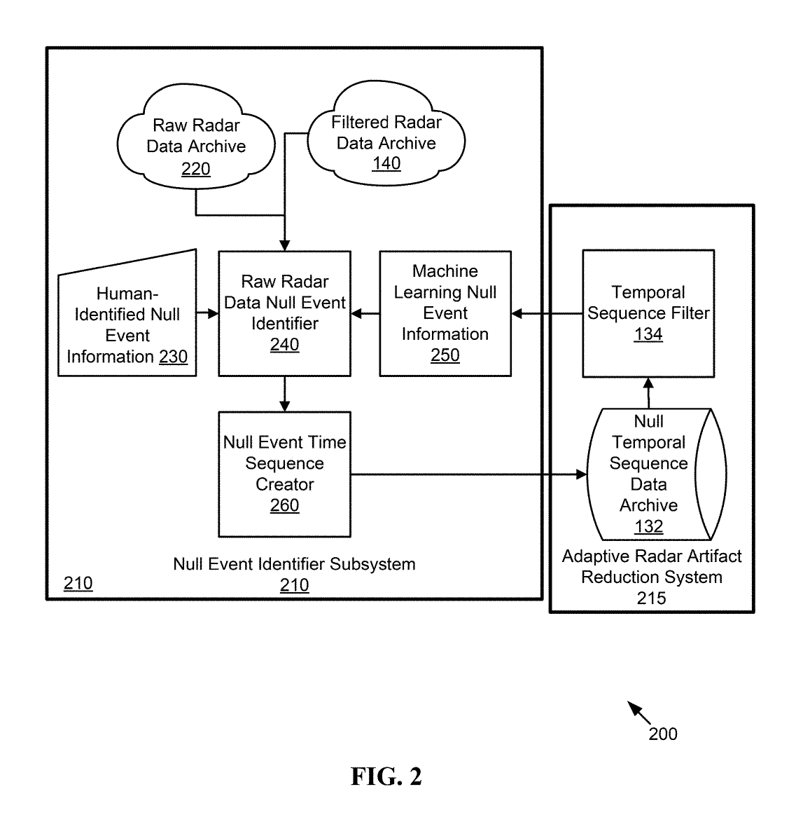

As shown by FIG. 1, a first exemplary embodiment of an adaptive radar artifact reduction system 100 for the detection of hydrometeors may include several components performing functionality ranging from the ingestion of derived radar data products to loading a relational database with processed and filtered radar data products. A second embodiment of the present invention may include a Null Event Identifier Subsystem (FIG. 2), which either via human guidance or machine learning techniques may identify, curate, and update null event lists for use with the System 100.

A first set of components 110, 112, 116 of the System 100 ingests, organizes, and collects the raw radar data products using a Radar Data Local Data Manager Organizer component 110 and a Raw Radar Data Collector component 116 respectively. The raw data may be periodically received and collected over a time window for analysis. Should sufficient radar-derived product data exist over this time window, filtering commences through a Singular Temporal Value Filter component 136, a Temporal Sequence Filter component 134, a Spatial Consistency Checker and Filler component 142, and finally, the Spatial Clustering Filter component 146. The Singular Temporal Value Filter component 136, the Temporal Sequence Filter component 134, the Spatial Consistency Checker and Filler component 142, and the Spatial Clustering Filter component 146 may be referred to collectively herein as filtering components 135, and the functionality performed by the filtering components 135 may be referred to as filtering the weather radar data. In alternative embodiments, the filtering components 135 may include different combinations of the Singular Temporal Value Filter component 136, the Temporal Sequence Filter component 134, the Spatial Consistency Checker and Filler component 142, and the Spatial Clustering Filter component 146.

The filtering components 135 compare radar data products (e.g., radar-derived hail size) to null event archive fingerprints stored in the Null Temporal Sequence Data Archive 132, and filter out additional anomalous values and spatial data patterns that are non-meteorological. Filtered and cleansed radar data may be passed to a Radar Data Spatial Interpolator component 156, for example, for transformation onto a geospatial grid that is readily storable in a relational database 150. Finally, this data is loaded into the Relational Database 150 via a Relational Database Loader 152 and made available to users and applications via a Data Extraction and Distribution Layer 162. These components are described in greater detail below.

The System 100 uses null events collected in the Null Temporal Sequence Data Archive 132. The Null Temporal Sequence Data Archive 132 may be manually populated, for example, based on prior indications of weather conditions such as hail by the System 100 where no instances of the indicated weather conditions were observed. Alternatively, the null events in the Null Temporal Sequence Data Archive 132 may be collected by an automated process. The Null Temporal Sequence Data Archive 132 may be a storage component, such as a hard drive or another bulk storage device, or the Null Temporal Sequence Data Archive 132 may be implemented, for example, using cloud storage.

Before the System 100 is run to filter out null events, historical radar products may be analyzed by a Null Event Identifier Subsystem 210 to identify and curate a list of null events and the data patterns associated with these null events, as shown by FIG. 2. This radar product-dependent event list (e.g., individual lists for hail, rain, and wind null events) provides fingerprints of events that are made up of artificial (non-meteorological) data that should be filtered out by the System 100. This null event list may be stored within the Null Temporal Sequence Data Archive 132 of the System 100.

The Null Event Identifier Subsystem 210 begins with an analysis of historical radar data. In the first embodiment, the Null Event Identifier Subsystem 210 retrieves archived raw Maximum Expected Size of Hail (MESH) radar-derived product data from cloud storage, the Raw Radar Data Archive. The MESH product is created at a 2-minute temporal frequency for the continental United States (CONUS) as a part of the Multi-Radar Multi-Sensor (MRMS) project. The MRMS project is a suite of CONUS radar-derived radar products created by the National Severe Storm Laboratory (NSSL) and disseminated by the National Centers for Environmental Prediction (NCEP) as a part of the National Weather Service (NWS) under the National Oceanic and Atmospheric Administration (NOAA).

The MESH hail size product is created by taking radar-return power from the horizontal polarization channel and applying an empirical transform to estimate the hail kinetic energy at each range gate in the radar volume. Hail can grow most rapidly at altitudes within a cloud where the temperature ranges between 0 and −38° C. Accordingly, data from a numerical weather model analysis of the vertical temperature profile are used to determine what altitudes are colder than 0° C., and then combines this temperature data from the model analysis with radar-based estimates of hail kinetic energy to yield an estimate of maximum hail size at a given location. The MRMS version of MESH is a spatial blend of all available CONUS NEXRAD WSR-88D MESH data, creating a uniform 1 km by 1 km geospatial grid of MESH data covering CONUS.

In other embodiments, the Null Event Identifier Subsystem 210 may retrieve other archived radar data or radar-derived products from other sources, either remotely or locally stored. For instance, the Null Event Identifier Subsystem 210 may retrieve radar-derived quantitative rainfall estimates or rotational shear values for identification of null rain or wind events.

The Null Event Identifier Subsystem 210 may identify null events in one or more ways, including manual identification and through machine learning techniques (see FIG. 2). In the first embodiment, manual identification of null events (Human-identified Null Event Information 230) may be passed into a Raw Radar Data Null Event Identifier 240 to process, isolate, and determine the specific temporal fingerprints that define null MESH events in the MRMS MESH data. Specifically, the Raw Radar Data Null Event Identifier 240 may create null event sequences by first identifying how MRMS MESH hail size normally varies between 2-minute intervals, which is characterized by smooth transitions between sizes rather than large, discrete jumps (i.e., in a step-function fashion). Using these normal behavior time sequences, null event fingerprints may be identified as anomalous and added to the null-event sequence list.

In the second embodiment, automated identification of null event sequences may be achieved through machine learning techniques (Machine Learning Real-time Null Event Information, 250). An artificial neural network utilizing a long short-term memory (LSTM) architecture is well suited for binary classification of temporal sequence data. It is specifically advantageous over a traditional recurrent neural network (RNN) in that it is capable of learning order dependence in sequence prediction problems at relatively large time lags such as those found within the present task of identifying null event sequences in the MRMS MESH data where relevant null sequence information may be contained at any location within an hour. LSTMs contain a structure known as a memory cell to accomplish learning by using “gates” to control information flow in and out of the memory. In the present application, these gates will determine the output activation of the input sequence, classifying the sequence as either a normal behavior sequence or a null sequence.

The Null Event Identifier Subsystem 210 may also utilize human-identified dates, times, and locations to isolate null events in time and space within the raw radar MESH data, to enable more precise identification of temporal fingerprints associated with null MESH events. Once a series of events is identified, the temporal sequences are sent to the Null Event Time Sequence Creator 260 to aggregate, format, and archive all the null event temporal fingerprints identified in the process. The logic and pattern forming that creates the null sequences may be the same logic that is used in the Temporal Sequence Filter component 134, and is described in detail later. The updated null event list may be stored in the main System in the Null Temporal Sequence Data Archive 132. The Null Temporal Sequence Data Archive 132 may take any form of storage, local or remote. In the first embodiment, the Null Temporal Sequence Data Archive 132 may be stored on hard disk for expedited access by the other parts of the System 100 (FIG. 1).

As mentioned, alternative embodiments may use other analyses to determine null events and pass along the associated temporal sequences to the Null Temporal Sequence Data Archive 132. One alternative embodiment involves assessing the level of “similarity” between a possible null sequence and all archived null sequences, on the one hand, and archived non-null temporal sequences. The required similarity score may be set by a human operator through a trial and error approach or set by a machine using machine learning techniques that refines the similarity score after iterative analysis of the predictive quality of a similarity threshold.

Under the first embodiment of the system 100, the Null Temporal Sequence Data Archive 132 may include roughly six months of archived MRMS MESH data to identify nearly 200 null event temporal sequences that were added to the Null Temporal Sequence Data Archive 132. These temporal fingerprints may cover a range of non-meteorological events, including a radar site conducting test patterns and radar beam ducting.

The System 100 may collect real-time or archived radar data or radar-derived products for analysis. The method of collection may be configured according to the type of radar data or radar-derived products. In one embodiment, the System 100 can be configured to access a remote server distributing such data on specified time intervals, and retrieving any new data it encounters (assessing the novelty of such data with techniques such as file size comparisons to previous data releases) and storing it in Raw Radar Data File Storage 112, which can take a variety of forms, including local or remote storage devices. In the first embodiment, however, the System 100 collects real-time radar-derived products that are constantly streaming in via an internet connect from NOAA's NCEP dissemination mechanism, the NOAA Radar Local Data Manager Distributor 102. For real-time data collection, under the first embodiment the System 100 includes a Radar Data Local Data Manager Organizer 110, which interfaces with remote servers that provide real-time data to users and organizes the incoming data. For example, in the first embodiment, the Radar Data Local Data Manager Organizer 110 may implement an open source third-party software package called the Local Data Manager (“LDM”) that directly connects to the dissemination server at NCEP via a specified Transmission Control Protocol port, enabling the NCEP server to push real-time radar product data to the System 100. The LDM software organizes and stores the received radar data on to the Raw Radar Data File Storage 112. The Raw Radar Data File Storage 112 may be, for example, a hard drive, or another appropriate bulk storage device, or via cloud storage

The Raw Radar Data Collector 116 performs several functions for collection, organization, and aggregation of collected raw radar and radar product data that may be correlated to weather events. Because the Raw Radar Data Collector 116 constructs temporal sequences based on a series of radar-based intensity measurements, the Raw Radar Data Collector 116 first organizes and aggregates the collected data series into discrete time intervals for use by the rest of the System 100. In the first embodiment, the Raw Radar Data Collector 116 is dedicated to the MRMS MESH 2-minute product disseminated and delivered from the NOAA Radar Local Data Manager Distributor 102. The raw data may also include, for example, data regarding rotation, precipitation, lighting, and energy returned to the radar. The Raw Radar Data Collector 116 receives the proper raw (for example, compressed gridded binary (GRIM)) files and properly relocates and renames them to a format and location expected by the remaining components of the System. For example, the Raw Radar Data Collector 116 may re-organize or re-name one or more data fields, and/or apply tags to data used to locate, identify, and/or categorize weather events. The Raw Radar Data Collector 116 runs continually as files are distributed in real-time with the process capturing new MESH files every 2-3 minutes.

Under the first embodiment, the Raw Radar Data Collector 116 periodically collects and aggregates the radar product data of the previous hour from Raw Radar Data File Storage 112, for example, once per hour. In other embodiments, and for other types of data or data products, the Raw Radar Data Collector 116 may aggregate radar data on a different schedule. Besides collection, organization, and aggregation, the Raw Radar Data Collector 116 component may provide a critical gatekeeping function, determining whether the System 100 will run in its entirety, or if the System 100 may instead utilize backup data sources or not filter at all and produce missing data values. The first embodiment of the Raw Radar Data Collector 116 may perform this gatekeeping function by counting the number of available radar data files, searching for additional files if the requisite number are not in Raw Radar Data File Storage 112, and utilizing a backup process if additional files cannot be located. Specifically, the Raw Radar Data Collector 116 searches for and counts the number of MRMS MESH 2-minute files available for the collection period of interest (an hour under the first embodiment), utilizing a buffer of extra files, for example, 6 extra files containing data collected before and/or after the one collection period to ensure hail events are properly captured at the beginning and end of the hour. For example, if the first event during a collection period (an hour, in this case) contains data that may appear incongruous with the subsequent samples, it may be useful to look at one or more samples immediately before the collection period to determine whether the first sample indicates an actual event or was just a spurious reading. Likewise, if the last event during a collection period contains data that may appear incongruous with the previous samples, it may be useful to look at one or more samples immediately after the collection period to determine whether the last sample indicates an actual event or was just a spurious reading.

The Raw Radar Data Collector 116 may expect that a predetermined number of files should be available for filtering, for example 36 files including the 30 2-minute files from the hour of concern plus the 6 buffer files previously described. If, for example, at least 30 files in total (including buffer files) exist, filtering may be allowed to proceed through the filtering components 135. The Raw Radar Data Collector 116 proceeds to open the aggregated GRIB files, extracts the relevant data, and constructs temporal sequences corresponding to that data for later use with the filtering components 135. For the first embodiment, the data extracted is the MRMS MESH hail size estimate and the respective geospatial coordinate system of the data as defined by the geospatial coordinate system provided within the files by NCEP. Temporal sequences are constructed as described below and passed along with the extracted data to the filtering components 135 via random-access memory (RAM) to ensure expedited processing of the data in near-real-time. In other embodiments, data may be passed into different storage media if near-real-time processing is not required or desired.

While the first embodiment uses samples of radar data collected every two minutes over a one hour sampling window, other sample windows may be used, for example 30 minutes or 90 minutes or more. Similarly, different sample collection frequencies may be used, for example, one sample per minute or one sample every four minutes.

If a small number of files (samples) are collected for a collection period, for example, if less than 30 files are collected, the Raw Radar Data Collector 116 may first attempt to download those missing files from the NOAA HTTP Radar Data Archive 130, a secondary HTTP server holding useful radar products (e.g., MRMS MESH 2-minute files). In other embodiments focusing on other weather perils and/or other data sources, the Raw Radar Data Collector 116 may query and retrieve data from other sources, either remotely or locally hosted.

If the missing files are successfully found and downloaded from the backup server 130, filtering then proceeds fully through the filtering components 135. However, if the missing files are not available, the System 100 may trigger a backup routine. In such scenarios, the Raw Radar Data Collector 116 passes the process off to the Backup Radar Data Collector 122 to download a backup radar-derived data product of similar data type to the preferred data product. Preferably, this backup product contains the same variable as the preferred product from the same product line (e.g., MRMS), and on the same (or similar) geospatial gridding system. In the first embodiment of the System 100, the backup radar product is the MRMS Max MESH 60-minute file, representing the maximum hourly MESH value over the specified hour. This backup product may be essentially similar to the 2-minute MESH files, but utilizing a different temporal frequency (for example, 60-minute versus 2-minute). Thus, its use is desirable as a backup to the main product.

The Backup Radar Data Collector 122 attempts to retrieve the backup files from the Raw Radar File Storage component 112, and if the backup files are missing, the Backup Radar Data Collector 122 attempts to download the backup file from the NOAA HTTP Radar Data Archive 130. Should the backup file exist, a separate processor may manipulate the data (Backup Radar Data Processor 148) in preparation for interpolation to a new geospatial grid, bypassing the filtering components 135. If the backup file doesn't exist, the Missing Radar Data File Generator 158, described below, may be initialized.

As initiated by the System 100 components described above, the Backup Radar Data Processor 148 and Missing Radar Data File Generator 158 may execute should not enough data be available for full filtering by the System 100. The Backup Radar Data Processor 148 may run on the chosen backup data file for the radar product of interest. Under the first embodiment, this component may extract data from the MRMS Max MESH 60-minute GRIB files, for example, hail size and geospatial coordinates, and pass the data to the Radar Data Spatial Interpolator component 156 for transformation, bypassing the filtering components 135. In alternative embodiments, the Graphical User Interface 170 may indicate that the displayed results are based on secondary and/or incomplete data.

Should the backup radar product not exist for the specific time period of interest, the Missing Radar Data File Generator 158 may create a comma-delimited (comma separated value (CSV)) file containing missing data values on the coordinate system utilized by the Radar Data Spatial Interpolator 156 for transformation of actual data. Given the potentially time sensitive uses of the data in downstream applications, generating missing data is important for maintaining timely functionality of these applications, providing them supplementary information to properly handle, format, and disseminate data in near-real time. Given that the missing data is projected on the coordinate system used by the Relational Database 150 already, the generated CSV may be directly loaded into the Relational Database 150 via the Relational Database Loader component 152.

Prior to null sequence based filtering carried out by the Temporal Sequence Filter 134, the System 100 may incorporate a number of coarser filters to eliminate missing data, minimal intensity events, and anomalous intensity signatures, lessening the processing demands and computational loads associated with filtering such data. In the first embodiment, when there are enough files (here, greater than or equal to 30 files) to process through the full artifact filter sequence for the specified time period, the System 100 accomplishes this coarser filtering through the Singular Temporal Value Filter 136. The Singular Temporal Value Filter 136 may perform, for example, one or more manipulations to improve the incoming raw radar data product.

For example, first, data points may be removed for the specific radar product, which are typically assigned a specific value by the product distributor (or values if multiple missing data designations are assigned). In the first embodiment, the first manipulation may isolate and homogenize missing or insignificant MESH hail data that NOAA assigns distinct numerical values to (e.g., −1.0 and −3.0 are numerical identifiers for missing or insignificant data within MRMS data products). Specifically, under the first embodiment the Singular Temporal Value Filter 136 searches for values of −3.0 and reassigns them to −1.0 so that the Temporal Sequence Filter 134 may properly interpret missing data of all types.

Second, the Singular Temporal Value Filter 136 isolates data values that reach a specific threshold to be utilized in later filtering components. The thresholds defined may be assigned based on important values for downstream users and applications, such as significant hail sizes that are known to cause property damage. For example, in the first embodiment, MRMS MESH 2-minute hail values at or greater than 0.45 inches may be isolated for additional analysis and filtering in subsequent steps. Values less than this threshold may be preserved for use in the later filtering methods.

Third, for radar data consisting of a series of short duration observations, the Singular Temporal Value Filter 136 identifies anomalous single value occurrences within the aggregated and isolated dataset. This process examines each radar observation (which for the first embodiment may occur at, for example, a 2-minute frequency) at every geospatial point for the time period of interest. If only a single observation period for a particular geospatial data point has a value at or exceeding the threshold determined in the previous step, that data value is reassigned to a specified, distinct value representing the missing value. For the first embodiment, this value may be, for example, −1.0. The justification for this reassignment stems from the fact that the meteorological events of interest (and associated perils) typically have temporal signatures that last longer than one 2-minute snapshot, and thus, should contain multiple non-negligible values spanning multiple timestamps per geospatial point. For longer duration radar observations, the Singular Temporal Value Filter 136 may not employ this reassignment step.

Thus, in the first embodiment the System 100, may specifically analyze if only one timestamp from the aggregated 2-minute MRMS MESH data is at or exceeds 0.45 inches for each geospatial point. If only one timestamp per geospatial point shows a MESH value at or greater than 0.45 inches, it is removed from the dataset. With the erroneous singular temporal values removed from the dataset, the data of the hour is passed onto the next component, the Temporal Sequence Filter 134, for example, via RAM. In alternative embodiments, the data may passed via other means, for example, via a communication network for embodiments where the data is distributed across two or more storage locations.

The Temporal Sequence Filter 134 provides the System 100 with the ability to identify, isolate, and remove data points that exhibit temporal patterns that are not consistent with that of meteorological events (such as hail, strong winds, or rain). The Temporal Sequence Filter 134 ingests a list of null sequences known to be associated with null events, from the Null Temporal Sequence Data Archive 132. This list is used to filter data points that match with any item in the ingested null-event list, and thus, to remove the erroneous data from the radar-derived data product.

Under the first embodiment the System 100 may assess sequences of 2-minute MRMS MESH hail sizes to classify and differentiate data points with erroneous and real hail size data. The null event 2-minute MRMS MESH temporal sequences used in the comparison were created in the Null Event Identifier Subsystem 200 and are read into RAM by the Filter. These null event sequences can be shorter in time when compared to the full expected length of a complete set (36 values total per geospatial point) of 2-minute MRMS MESH values for a particular hour, supplying a variety of null temporal sequence lengths to compare to the full complement of MRMS MESH data.

The numerical values used in the compared sequences may be assigned based on a rubric where each value uniquely maps to a particular change in event intensity (such as MRMS MESH hail size in the first embodiment). The changes in intensity (e.g., MESH hail size) that are utilized to generate a temporal sequence may also vary depending on the resolution of the available intensity measurements and end user needs. In the first embodiment, temporal sequences may be constructed by assigning values to each pair of 2-minute MESH values according to the following procedure on a per data point basis shown by Table 1:

TABLE 1

| TSV | Interpretation based on the temporal sequence value (TSV) |
|---|---|
| −1 | indicates no hail for two consecutive 2-minute periods. |
| 0 | indicates that a non-zero MESH value has changed to another non-zero MESH value and |
| | the difference between the two values is less than 1.5 inches. |
| 1 | indicates that no hail is immediately followed by a MESH value greater than or equal to |
| | 0.45 inches. |
| 2 | indicates that a MESH value greater than 0.45 inches is immediately followed by no hail. |
| 3 | indicates that consecutive MESH values greater than or equal to 0.45 inches are identical. |
| 4 | indicates that consecutive MESH values less than 0.45 inches are identical. |
| 5 | indicates that no hail is immediately followed by a MESH value greater than or equal to |
| | 1.5 inches. |
| 6 | indicates that a MESH value greater than or equal to 1.5 inches is immediately followed |
| | by no hail. |
| 7 | indicates that no hail is immediately followed by a MESH value less than 0.45 inches. |
| 8 | indicates that a MESH value less than 0.45 inches is immediately followed by no hail. |
| 9 | indicates that the absolute change between MESH values is greater than or equal to 2.5 |
| | inches |

For example a set of MESH values [−1, −1, −1, −1, 0.23, 0.57, 1.31, 1.31, 1.31, 0.97, −1, −1, −1, −1] corresponds to the temporal sequence [−1, −1, −1, 7, 0, 0, 3, 3, 0, 2, −1, −1, −1]. Utilizing sequence logic shown in Table 1, the MRMS MESH data for the hour is analyzed in the Temporal Sequence Filter 134 in comparison to the MRMS MESH null temporal sequences, removing any geospatial points that match any of the null temporal sequences. As previously mentioned, the lengths of the null temporal sequences are smaller than that of the full temporal length of the MRMS MESH data, and thus, the system iteratively assesses subsets of the full MRMS dataset to each null event sequence for each geospatial location of interest.

In alternative embodiments the Temporal Sequence Filter 134 may utilize other matching methodologies. For example, one alternative embodiment may compare the similarity of the sequence in question to a large set of null sequences and remove the corresponding geospatial point if a certain similarity threshold is reached, as set through human intervention or derived from machine-learning techniques.

With the erroneous temporal sequences removed, the Temporal Sequence Filter 134 removes the time dimension from the data by calculating the maximum hail size over the specified maximum duration (an hour in the first embodiment) for each geospatial point. Reducing the time dimension may yield a substantially smaller dataset that may be faster to transfer, display, and format for the intended use cases by downstream applications. For other embodiments, the System 100 can keep the time dimension intact, creating time varying series of derived radar data at any requested frequency for use in downstream applications. This newly formed 2-dimensional spatial array of intensity measurements (60-minute max MESH values in the first embodiment) is passed to the Spatial Consistency Checker and Filler 142 via RAM for additional cleansing.

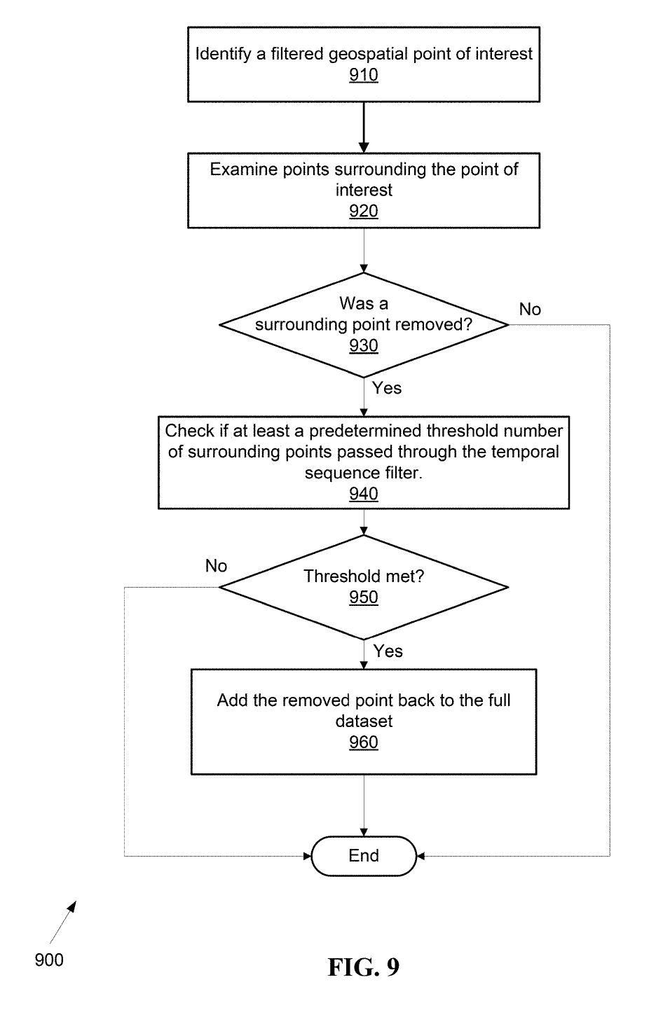

While the Temporal Sequence Filter 134 removes geospatial points with anomalous temporal sequences for a specific time period of data, the Spatial Consistency Checker and Filler 142 ensures that the removed points were not part of a spatially consistent meteorological feature. FIG. 9 is a flowchart 900 of an embodiment of an exemplary process performed by the Spatial Consistency Checker and Filler 142. It should be noted that any process descriptions or blocks in flowcharts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

As shown by blocks 910, 920, for each filtered geospatial point, the geospatial points surrounding the point of interest are examined to see if any of those points were removed. If a surrounding point was removed, as shown by block 930, the Spatial Consistency Checker and Filler 142 adds the filtered geospatial point back to the full dataset with its original value as shown by block 960, if some number of surrounding points passed through the Temporal Sequence Filter 134, as shown by blocks 940, 950. In the first embodiment, if 7 or more points surrounding the point of interest are not removed by the Temporal Sequence Filter 134 for having an anomalous MRMS MESH time sequence, the filtered geospatial point is added back to the full dataset with its original data value. The number of points used to return a geospatial coordinate back to the full dataset may change dependent on the dataset of concern, and/or the strictness of the filtering desired.

Under the first embodiment, the System 100 includes additional spatial filtering for radar-derived products to complement the temporal filtering of the Temporal Sequence Filter 134. Spatial cluster analysis performed by the Spatial Clustering Filter 146 identifies and differentiates spatial patterns of meteorological features from non-meteorological features. Since meteorological features have distinct spatial shapes (such as a hail swath or tornado path), these may be spatially distinguished from those spatial patterns associated with radar artifacts. As described further below, these shapes may be defined by the number of geospatial points within a cluster as well as the size of the cluster in space. The metrics employed to identify meteorologically significant spatial patterns are dependent on the meteorological phenomena of interest as well as the radar-derived data product observing the phenomena of interest.

In the first embodiment, the Spatial Clustering Filter 146 uses a spatial clustering routine, specifically a density-based spatial clustering of applications with noise (DBSCAN) algorithm performed on the array of calculated 60-minute maximum MESH values greater than or equal to 0.01 inches. In other embodiments, different spatial clustering detection algorithms may be used. The Spatial Clustering Filter 146 identifies clusters or “hail swaths” based on a minimum number of geospatial points (8) and a specified distance (3 geospatial points) to be considered as a cluster. For example, after the clusters are identified, if more than 50% of the points in an identified cluster are retained, the entire cluster is retained. Conversely, if more than 50% of the points are filtered out by the Temporal Sequence Filter 134, the entire cluster is removed from the dataset. In alternative embodiments, these percentages may be different depending on user preference and/or confidence in the temporal sequence filtering.

Once the Spatial Clustering Filter 146 completes, the spatial 2-dimensional array of the corrected radar-derived product may be passed, for example via RAM or some other storage or transmission protocol, to the Radar Data Spatial Interpolator 156 for transformation to the geospatial gridding system utilized by the Relational Database 150.

With the filtering complete, the cleansed data is ready to be transformed to a format for storage in the Relational Database 150. In the first embodiment, the Radar Data Spatial Interpolator 156 maps the cleansed data to a geodesic grid, for example, a hexagonal grid with a 1-km spatial resolution over CONUS, though in other embodiments different cell shapes and sizes and different geographical coordinates and/or orientations are also possible. The current geodesic gridding system is ideal for storing numerous disparate datasets on a uniform grid, as the gridding system is defined as a suite of telescoping grids. Telescoping grids are defined such that several gridding systems of varying spatial resolutions share points in space so that a variety of datasets (all with different spatial resolutions) can be compared easily by using common points each of the grid systems share. The exemplary 1-km spatial resolution grid shares discrete points with several other pre-defined geodesic grids with spatial resolutions of 500-m, 2-km, 4-km, 7.5-km, 15-km, and 30-km, and thus, can be combined for further analysis and analytics with other datasets stored within the same gridding system.

Interpolation may be carried out in a variety of different ways. In the first embodiment, the Radar Data Spatial Interpolator 156 may transform the calculated 60-minute MESH data, for example, utilizing a cubic spline spatial interpolation to the specified geospatial geodesic grid, then outputs the processed data, for example, to a CSV file on temporary hard drive storage. This CSV file may then be passed to the Relational Database Loader 152 for loading into the specified Relational Database 150, and may also be sent for storage on the Filtered Radar Data Archive 140 for backup and/or use with other applications or processes.

To load the processed data into the Relational Database 150, the Relational Database Loader 152 may read the processed CSV into RAM, parse the associated metadata, and then utilize configurations specific to the Relational Database 150 to load the data into its respective database table structure and format. In the first embodiment, this CSV metadata may include column headers and a naming structure for the processed MRMS MESH data such as the timestamp of the specific hour, geospatial point identifiers (e.g., station IDs) as well as the MESH values associated with each geospatial point. This metadata plus the actual data array is then passed to the Relational Database 150 and the database load is initiated via executed, for example, via Structured Query Language (SQL) commands. Once the data is successfully loaded, the CSV may be removed from temporary hard drive storage and the System 100 is complete for the hour of concern.

The Data Extraction and Distribution Layer 162 generally begins with extracting the filtered radar-derived product from the Relational Database 150 for example, by utilizing formatted SQL queries. In the first embodiment, the queries may be structured such that hail size data (e.g., the filtered MESH data) is extracted either for a specified location across a range of times, or as daily summaries for many point locations (e.g., statewide daily maximum hail sizes for thousands of geospatial 1 km geodesic points). The former type of extraction is typically focused on forensic investigation at a single location while the latter is utilized for situational awareness and the spatial impact of a weather event over a specified area.

A variety of methods may be used to optimize the interaction between the application servers and queries to the Relational Database 150, depending on the types of servers and database utilized. For example, in one embodiment, the applications servers may be Java based and interact with data efficiently by utilizing a Hibernate data mapping layer.

Access to the data may be provided in a variety of ways. One exemplary embodiment allows a user to hit a RESTful (representational state transfer) API (application program interface) endpoint to retrieve the data through Java based database queries. These API endpoints are available for both aforementioned use cases.

Data may be returned through these endpoints in a variety of formats. One exemplary embodiment returns the requested data in GeoJSON (a geographic data structure) format or as customized JSON objects depending on the downstream use case. For visualization within the Graphical User Interface 170, GeoJSON objects are returned to display a spatial representation of the data on a map interface.

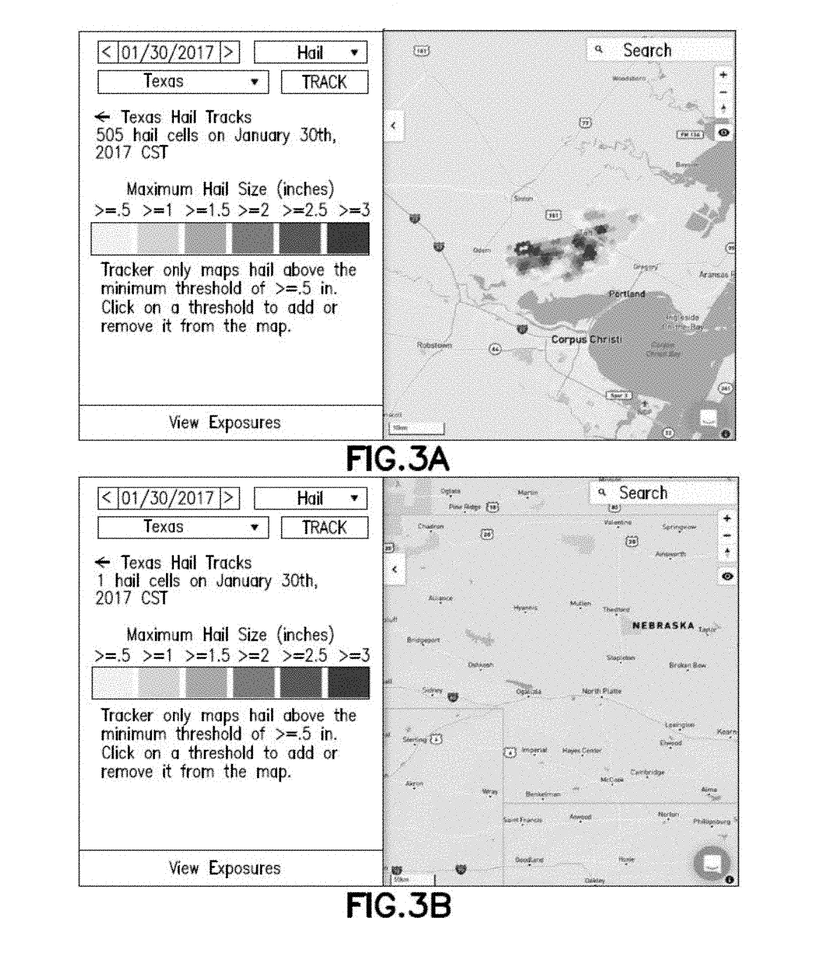

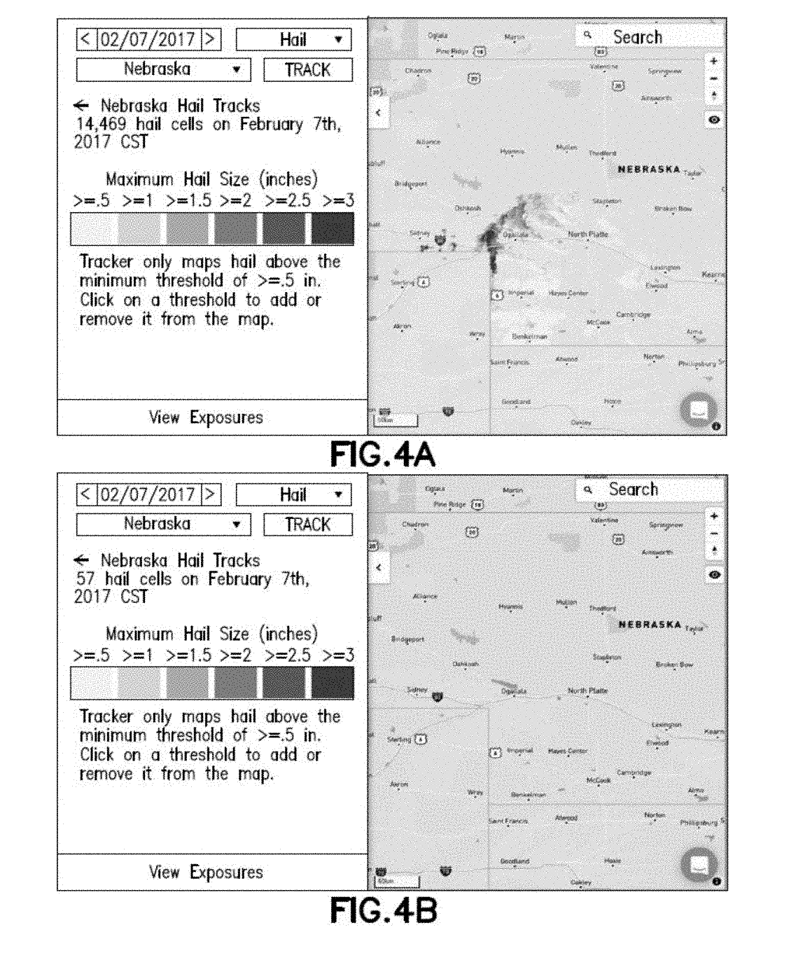

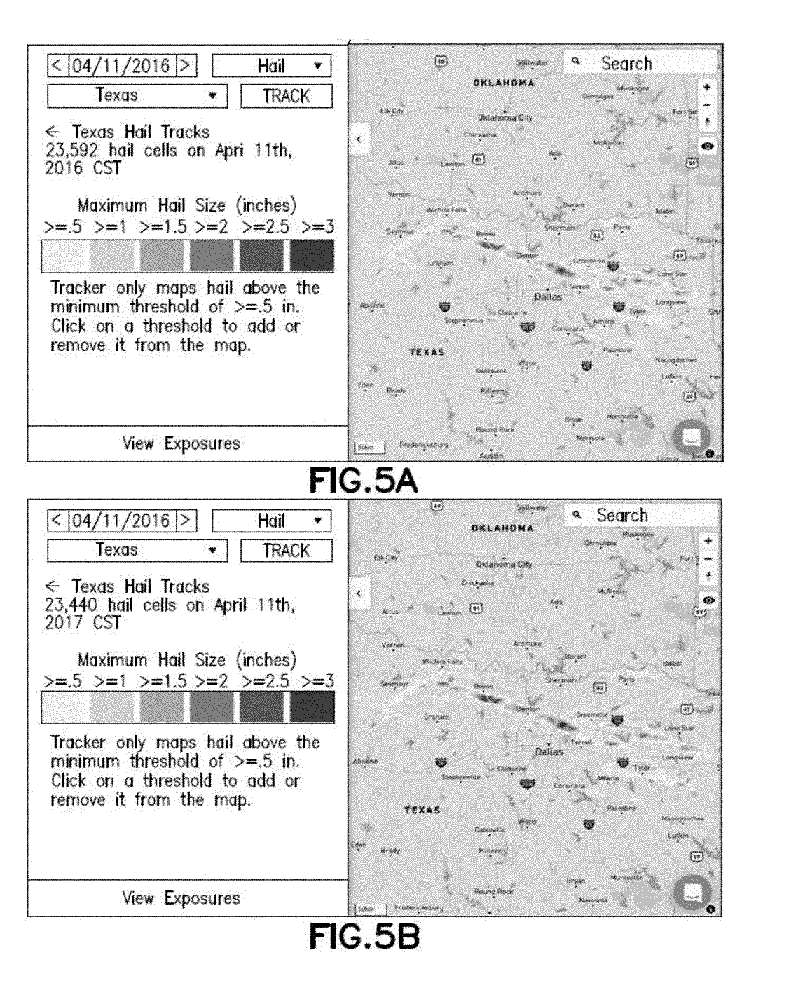

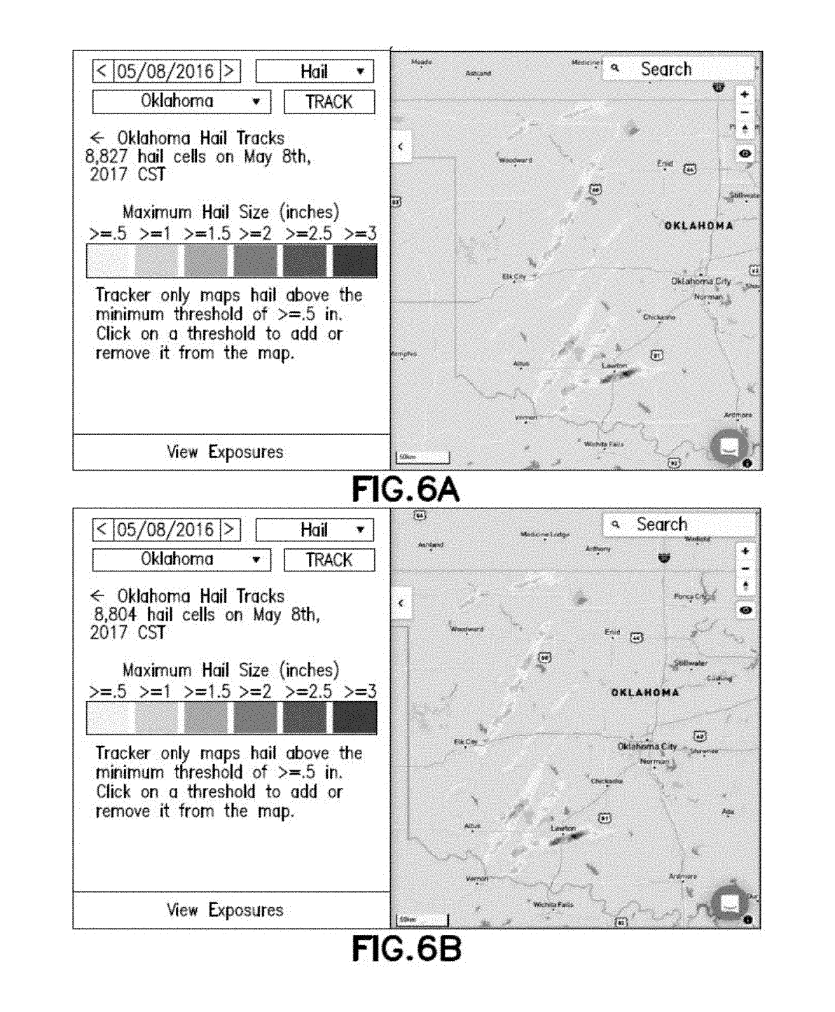

FIGS. 3A-B and 4A-B show instances of falsely identified hail, while FIGS. 5A-B and 6A-B show instances of observed hail events. FIGS. 3A, 4A, 5A, and 6A show raw radar data, while the visualization component of the filtered data under the first embodiment is shown in FIGS. 3B, 4B, 5B, and 6B. This mapping provides users an interface to determine the spatial extent of hail events as indicated by maximum daily MESH hail size values. The success of the System 100 (FIG. 1) and its artifact reduction methodologies may be seen by the substantial reduction of null events being displayed in the Graphical User Interface (FIGS. 3A-B, 4A-B) while still retaining real hail events (FIGS. 5A-B, 6A-B).

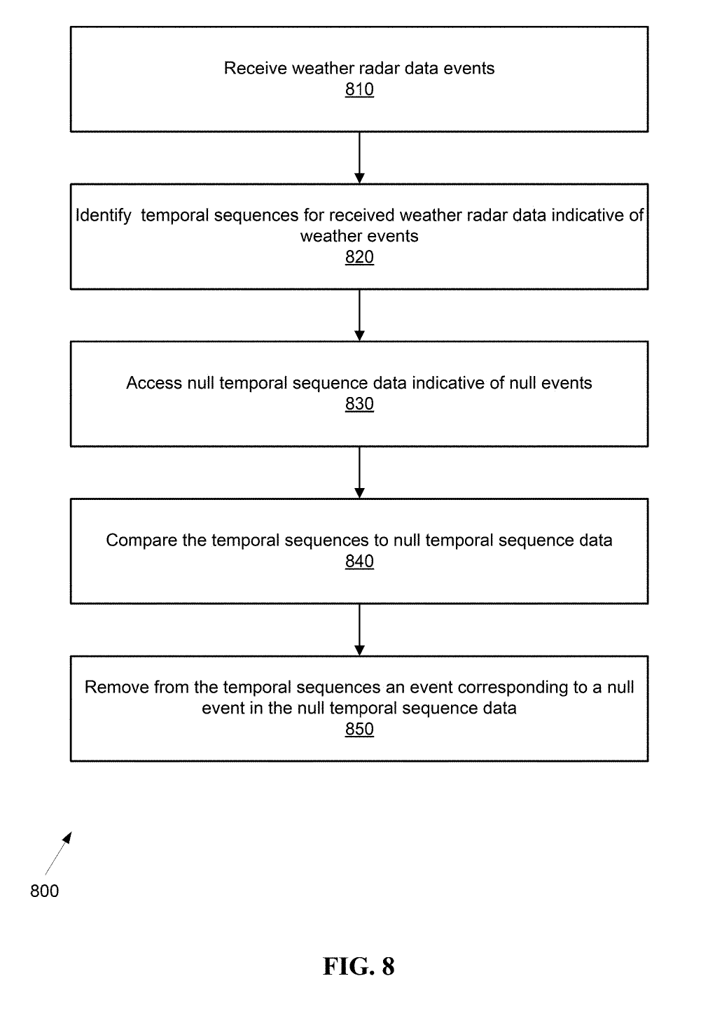

FIG. 8 is a flowchart 800 of a first exemplary method for adaptive radar artifact reduction. Weather radar data events are received, as shown by block 810. For example, a plurality of files containing real-time weather radar data may be received from the NOAA Radar Local Data Manager Distributor 102 (FIG. 1), Temporal sequences are identified for received weather radar data indicative of weather events as shown by block 820. Null temporal sequence data is accessed, as shown by block 830. For example, the null temporal sequence data may include data falsely indicating the presence of hydrometeors stored in the Null Temporal Sequence Data Archive 132 (FIG. 2). The temporal sequences are compared to null temporal sequence data, as shown by block 840. A temporal sequence corresponding to a null event is removed from the temporal sequences that may ultimately be passed through to downstream processes, as shown by block 850.

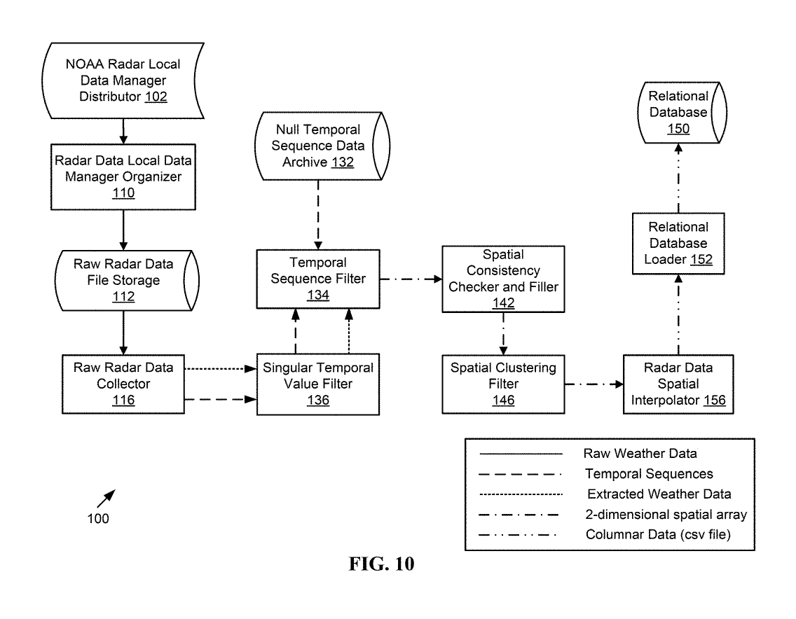

FIG. 10 is a schematic diagram of the first exemplary embodiment of the radar artifact reduction system indicating the data types and locations of data transformation. Data exchanged between the NOAA Radar Local Data Manager Distributor 102, the Radar Data Local Data Manager Organizer 110, the Raw Radar Data File Storage 112, and the Raw Radar Data Collector 116 is generally raw weather data in grib2 file formats, the format provided by NOAA. Such files are not human-readable, but a metadata mapping schema used to extract usable information is shown in Table 2.

TABLE 2

| MRMSVariableName | Search Criteria | Name | Units | stepType |
|---|---|---|---|---|
| MRMS_MESH_00.50 | parameterNumber=28, | Unknown | Unknown | Instant |
| | typeOfLevel=′heightAboveSea′, | | | |
| | unitsOfFirstFixedSurface=′102′, | | | |
| | scaledValueOfFirstFixedSurface= | | | |
| | 500, | | | |
| | scaleFactorOfFirstFixedSurface= | | | |
| | 0, | | | |
| | scaledValueOfSecondFixedSurface=0, | | | |
| | scaleFactorOfSecondFixedSurface=1 | | | |
| MRMS_MESH_Max_30min | parameterNumber=29, | Unknown | Unknown | Instant |
| | typeOfLevel=′heightAboveSea′, | | | |
| | unitsOfFirstFixedSurface=′102′, | | | |
| | scaledValueOfFirstFixedSurface= | | | |
| | 500, | | | |
| | scaleFactorOfFirstFixedSurface= | | | |
| | 0, | | | |
| | scaledValueOfSecondFixedSurface=0, | | | |
| | scaleFactorOfSecondFixedSurface=1 | | | |
| MRMS_MESH_Max_60min | parameterNumber=30, | Unknown | Unknown | Instant |
| | typeOfLevel=′heightAboveSea′, | | | |
| | unitsOfFirstFixedSurface=′102′, | | | |
| | scaledValueOfFirstFixedSurface= | | | |
| | 500, | | | |
| | scaleFactorOfFirstFixedSurface= | | | |
| | 0, | | | |
| | scaledValueOfSecondFixedSurface=0, | | | |
| | scaleFactorOfSecondFixedSurface=1 | | | |
| MRMS_POSH_00.50 | parameterNumber=27, | Unknown | Unknown | Instant |
| | typeOfLevel=′heightAboveSea′, | | | |
| | unitsOfFirstFixedSurface=′102′, | | | |
| | scaledValueOfFirstFixedSurface= | | | |
| | 500, | | | |
| | scaleFactorOfFirstFixedSurface= | | | |
| | 0, | | | |
| | scaledValueOfSecondFixedSurface=0, | | | |
| | scaleFactorOfSecondFixedSurface=1 | | | |
| MRMS_SHI_00.50 | parameterNumber=26,typeOfLevel= | Unknown | Unknown | Instant |
| | ′heightAboveSea′,unitsOfFirst | | | |
| | FixedSurface=′102′,scaledValue | | | |
| | OfFirstFixedSurface=500,scale | | | |
| | FactorOfFirstFixedSurface=0,scaled | | | |
| | ValueOfSecondFixedSurface=0, | | | |
| | scaleFactorOfSecondFixedSurface=1 | | | |

Data exchanged between the Raw Radar Data Collector 116, the Singular Temporal Value Filter 136, and the Temporal Sequence Filter 134 may include both temporal sequences and extracted weather data. The extracted weather data may include uncompressed raw data that has been collected over a number of two minute intervals, as described above. The Null Temporal Sequence Data Archive 132 provides temporal sequences to the Temporal Sequence Filter 134. The Temporal Sequence Filter 134, Spatial Consistency Checker and Filler 142 Spatial Clustering Filter 146, and Radar Data Spatial Interpolator 156 pass data in the format of a 2-dimensional spatial array, which may include a limited set of data, for example, a field indicating the maximum hail size and geographical coordinated, for example, latitude/longitude corresponding to the location of the maximum hail size, while omitting the timestamps. The data exchanged between the Radar Data Spatial Interpolator 156, the Relational Database Loader 152, and the Relational Database 150 may be, for example, columnar data in a csv file, an example of which is show in Table 3:

TABLE 3

| timestamp | station_id | MESH60min_in |
|---|---|---|
| 2017-08-15T23:00:00Z | 2208556245 | 2.6 |
| 2017-08-15T23:00:00Z | 2208649454 | 2.527 |
| 2017-08-15T23:00:00Z | 2208698700 | 2.461 |
| 2017-08-15T23:00:00Z | 2160176108 | 2.423 |
| 2017-08-15T23:00:00Z | 2208791985 | 2.337 |
| 2017-08-15T23:00:00Z | 2251312764 | 2.336 |
| 2017-08-15T23:00:00Z | 2251398868 | 2.242 |
| 2017-08-15T23:00:00Z | 2251262398 | 2.237 |
| 2017-08-15T23:00:00Z | 2160176943 | 2.233 |
| 2017-08-15T23:00:00Z | 2251449026 | 2.232 |
| 2017-08-15T23:00:00Z | 2160027720 | 2.195 |
| 2017-08-15T23:00:00Z | 2251499598 | 2.193 |
| 2017-08-15T23:00:00Z | 2251176177 | 2.192 |
| 2017-08-15T23:00:00Z | 2160225951 | 2.15 |
| 2017-08-15T23:00:00Z | 2160226888 | 2.143 |
| 2017-08-15T23:00:00Z | 2208606295 | 2.114 |

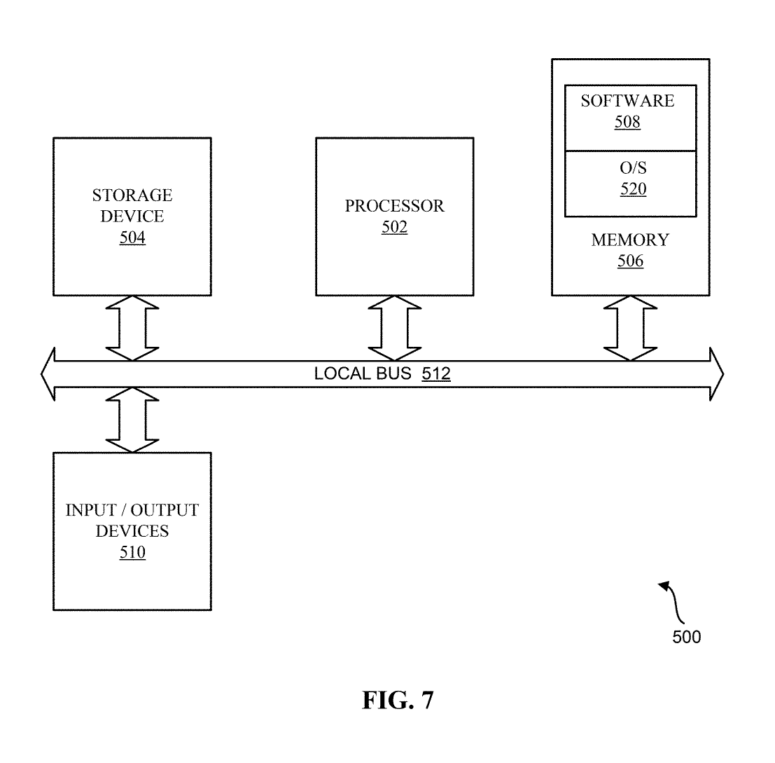

The present System 100 for executing the functionality described in detail above may be a computer, an example of which is shown in the schematic diagram of FIG. 7. The system 500 contains a processor 502, a storage device 504, a memory 506 having software 508 stored therein that defines the abovementioned functionality, input and output (I/O) devices 510 (or peripherals), and a local bus, or local interface 512 allowing for communication within the system 500. The local interface 512 can be, for example but not limited to, one or more buses or other wired or wireless connections, as is known in the art. The local interface 512 may have additional elements, which are omitted for simplicity, such as controllers, buffers (caches), drivers, repeaters, and receivers, to enable communications. Further, the local interface 512 may include address, control, and/or data connections to enable appropriate communications among the aforementioned components.

The processor 502 is a hardware device for executing software, particularly that stored in the memory 506. The processor 502 can be any custom made or commercially available single core or multi-core processor, a central processing unit (CPU), an auxiliary processor among several processors associated with the present system 500, a semiconductor based microprocessor (in the form of a microchip or chip set), a macroprocessor, or generally any device for executing software instructions.

The memory 506 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 506 may incorporate electronic, magnetic, optical, and/or other types of storage media. Note that the memory 506 can have a distributed architecture, where various components are situated remotely from one another, but can be accessed by the processor 502.

The software 508 defines functionality performed by the system 500, in accordance with the present invention. The software 508 in the memory 506 may include one or more separate programs, each of which contains an ordered listing of executable instructions for implementing logical functions of the system 500, as described below. The memory 506 may contain an operating system (O/S) 520. The operating system essentially controls the execution of programs within the system 500 and provides scheduling, input-output control, file and data management, memory management, and communication control and related services.

The I/O devices 510 may include input devices, for example but not limited to, a keyboard, mouse, scanner, microphone, etc. Furthermore, the I/O devices 510 may also include output devices, for example but not limited to, a printer, display, etc. Finally, the I/O devices 510 may further include devices that communicate via both inputs and outputs, for instance but not limited to, a modulator/demodulator (modem; for accessing another device, system, or network), a radio frequency (RF) or other transceiver, a telephonic interface, a bridge, a router, or other device.

When the system 500 is in operation, the processor 502 is configured to execute the software 508 stored within the memory 506, to communicate data to and from the memory 506, and to generally control operations of the system 500 pursuant to the software 508, as explained above.

When the functionality of the system 500 is in operation, the processor 502 is configured to execute the software 508 stored within the memory 506, to communicate data to and from the memory 506, and to generally control operations of the system 500 pursuant to the software 508. The operating system 520 is read by the processor 502, perhaps buffered within the processor 502, and then executed.

When the system 500 is implemented in software 508, it should be noted that instructions for implementing the system 500 can be stored on any computer-readable medium for use by or in connection with any computer-related device, system, or method. Such a computer-readable medium may, in some embodiments, correspond to either or both the memory 506 or the storage device 504. In the context of this document, a computer-readable medium is an electronic, magnetic, optical, or other physical device or means that can contain or store a computer program for use by or in connection with a computer-related device, system, or method. Instructions for implementing the system can be embodied in any computer-readable medium for use by or in connection with the processor or other such instruction execution system, apparatus, or device. Although the processor 502 has been mentioned by way of example, such instruction execution system, apparatus, or device may, in some embodiments, be any computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the processor or other such instruction execution system, apparatus, or device.

Such a computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the system 500 is implemented in hardware, the system 500 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

In summary, the above embodiments illustrate an automated system to ingest and cleanse real-time radar product data to isolate impactful weather events that result from meteorological phenomena such as rain, hail, and wind (rotational and straight-line). The filtering approach focuses on identifying radar artifacts resulting in null events, that is, instances in which radar data contains signatures for intense rain, hail, or wind, but no hydrometeors are present. The system refines itself as null events occur, increasing the accuracy of the filter as time progresses.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system for detection of misidentified hydrometeors comprising:
a raw radar null event identifier configured to receive weather radar data and null event information and identify a null event in the weather radar data; and
a null event time sequence creator configured to receive the null event from the raw radar null event identifier and form a null event time sequence based on the null event.

2. The system of claim 1, wherein the weather radar data comprises raw weather data and/or filtered radar data.

3. The system of claim 1, wherein the weather radar data comprises Maximum Expected Size of Hail (MESH) radar-derived product data.

4. The system of claim 1, wherein the null event information comprises one of the group consisting of machine learning null event information and human identified null event information.

5. The system of claim 1, further comprising a machine learning null event information module comprising an artificial neural network configured to produce the null event information.

6. The system of claim 5, wherein the neural network further comprises a long short-term memory (LSTM) architecture.

7. The system of claim 6, wherein the LSTM architecture comprises a plurality of gates configured to determine an output activation of a received input sequence and classify the sequence as either a normal behavior sequence or a null sequence.

8. A computer based method for detection of misidentified hydrometeors comprising the steps of:
receiving weather radar data;
receiving null event information; and
identifying a null event in the weather radar data based upon the null event information.

9. The method of claim 8, wherein the weather radar data comprises raw weather radar data and/or filtered weather radar data.

10. The method of claim 8, further comprising the step of forming a null event time sequence based on the null event.

11. The method of claim 10, further comprising the step of storing the null event time sequence in a null temporal sequence data archive.

12. The method of claim 8, wherein identifying a null event in the weather data further comprises:
identifying expected hail size variations over time,
comparing changes in reported hail sizes over time according to the weather radar data with the expected hail size variations over time; and
if the changes in reported hail sizes over time are inconsistent with the expected hail size variations over time, declaring the reported hail sizes over time as anomalous.

13. The method of claim 12, wherein the expected hail size variations over time exhibit smooth transitions rather than step-function variation.

14. The method of claim 8, wherein the null event information further comprises machine learning null event information and/or human identified null event information.

15. The method of claim 8, further comprising the step of populating an archive of null temporal sequence data.

16. The method of claim 8, wherein identifying a null event in the weather radar data further comprises the steps of:
determining an output activation of a received input sequence; and
classifying the sequence as either a normal behavior sequence or a null sequence.
